(19) United States
(12) Patent Application Publication
(10) Pub. No.: US 2020/0354884 A1
(43) Pub. Date: Nov. 12, 2020

(54) Functionalized Fibers for Removal of Contaminants in Water and Soil

(71) Applicant: The Trustees of the Stevens Institute of Technology, Hoboken, NJ (US)

(72) Inventors: Xiaoguang Meng, Piscataway, NJ (US); Jinshan Wei, Jersey City, NJ (US)

(73) Assignee: The Trustees of the Stevens Institute of Technology, Hoboken, NJ (US)

(21) Appl. No.: 16/869,436

(22) Filed: May 7, 2020

Related U.S. Application Data
(60) Provisional application No. 62/844,665, filed on May 7, 2019.

(51) Int. Cl. D06M 13/332; B01J 20/26; B01J 20/28; D06M 13/02; C02F 1/28; B09C 1/08

(52) U.S. Cl. CPC D06M 13/332; B01J 20/265; B01J 20/28023; D06M 2101/26; C02F 1/288; B09C 1/08; D06M 13/02

(57) ABSTRACT

Functionalized fibers adapted to remove contaminants from water and soil are produced in accordance with a single-step process that involves treating an acrylic fiber with an amination reagent to form a functionalized acrylic amino fiber. By way of another single-step process, functionalized acrylic amino fibers are treated with an alkylating reagent to form functionalized acrylic quaternary amino fibers.

### CROSS-REFERENCE TO RELATED APPLICATIONS

This application claims priority to U.S. provisional application Ser. No. 62/844,665, filed on May 7, 2019, the entire contents of which are incorporated herein by reference.

### FIELD OF THE INVENTION

The present invention relates to functionalized fibers. Specifically, it pertains to the manufacture of fiber adsorbents which can, for example, remove contaminants from water and soil.

### BACKGROUND OF THE INVENTION

Inorganic contaminants, such as arsenic, chromium, selenium, lead, mercury, copper, cadmium, phosphate and nitrate are commonly found in industrial wastewater, municipal wastewater, and drinking water sources. Co-precipitation with ferric and aluminum chemicals and adsorption with granular metal oxides and ion exchange resins are conventional treatment techniques for the treatment of the heavy metals in water.

### SUMMARY OF THE INVENTION

Functionalized fibers are new types of adsorbents with high adsorption capacity and rapid adsorption rate, compared to granular adsorbents. The adsorptive fibers can be used to make many types of filter materials, such as nonwoven filter fabric and string wound filters, which are convenient to use, and filtration cartridges.

Typically, the production of fibers requires multiple chemical steps and chemical reagents. However, in the process of the present invention, an acrylic fiber is treated with an amination reagent in one step to form acrylic amino adsorbents with high adsorption capacity for both cations and anions. This process is simple and consumes less reagent. The novel amination processes reduce the material and production costs and reduce chemical wastes generated in the production processes. Acrylic amino fibers are produced with a one-step functionalization process via application of an amination reagent, which fibers can then be converted into acrylic quaternary amino fibers with a second one-step functionalization process involving a second amination reagent.

The process is used for preparing functionalized acrylic fiber adsorbents containing high densities of primary, secondary, and quaternary amino functional groups. The modified acrylic amino fibers known as acrylic quaternary amino fibers are a new adsorbent entirely. The functionalization process is simple and efficient and obtained fibers have higher adsorption capacities than the existing fiber adsorbents.

The manufactured fiber adsorbents can be used for adsorption of contaminants, such as arsenate, chromate, phosphate, nitrate, and lead, in water. They can also be used for removal and recovery of phosphate and nitrate from wastewater and surface water. To this end, the fibers can be used in filters and can also be put directly in water treatment basins, storm water basins, streams, and ponds (e.g., in the form of nets or long strings). Other applications include recovery of nutrient elements and treatment of soil (e.g., via removal of chromium).

### BRIEF DESCRIPTION OF THE FIGURES

For a more complete understanding of the present disclosure, reference is made to the following detailed description of an exemplary embodiment considered in conjunction with the accompanying drawings, in which:

FIG. 1 is a flow chart for the production of acrylic fibers in accordance with an embodiment of the present invention;

FIG. 2 is a FTIR spectrum of (a) acrylic fiber (AF) and (b) acrylic amino fiber (AAF);

FIG. 3 is a FTIR spectrum of acrylic quaternary amino fiber (AQAF);

FIG. 4 is a graph demonstrative of phosphate adsorption kinetics by AAF, with initial phosphate concentration=5, 20, 50 mg-P/L, fiber adsorbent content=0.2 g/L, ionic strength=0.01M NaCl, initial pH 7.0±0.1;

FIG. 5 is a graph showing column filter results of phosphate from spiked tap water at different solution pH;

FIG. 6 is a plot showing adsorption of arsenate As(V) by AAF, fiber adsorbent content=0.2 g/L, 0.01 M NaCl solution, adsorption time=4 h, pH 7.0±0.1;

FIG. 7 is a plot showing adsorption of selenium on AAF, fiber adsorbent content=0.2 g/L, tap water, adsorption time=4 h, pH 7.0±0.1;

FIG. 8 is a plot showing adsorption of Cr(VI) by AAF, fiber adsorbent content=0.2 g/L, ionic strength=0.01 M NaCl, adsorption time=4 h, pH=6.0±0.2;

FIG. 9 is a plot showing adsorption of Cr(III) by AAF, fiber adsorbent content=0.2 g/L, ionic strength=0.01 M NaCl, adsorption time=4 h, pH=5.0±0.2;

FIG. 10 is a plot showing lead adsorption using AAF, fiber adsorbent content=0.2 g/L, ionic strength=0.01 M KNO₃, adsorption time=4 h, pH=5.0±0.2;

FIG. 11 is a plot showing nitrate adsorption using AQAF, fiber absorbent content=0.2 g/L, adsorption time=4 h, pH 7.0±0.2, 20° C.;

FIG. 12 is a plot showing column filter properties of AQAF on nitrate removal (experimental condition: influent nitrate concentration=20 mg-N/L, tap water, pH 7.0, EBCT 3 min); and

FIG. 13 is a graph showing nitrate removal by regenerated AQAF fibers, with 0.1 NaOH as the regeneration solution.

### DETAILED DESCRIPTION OF AN EXEMPLARY EMBODIMENT

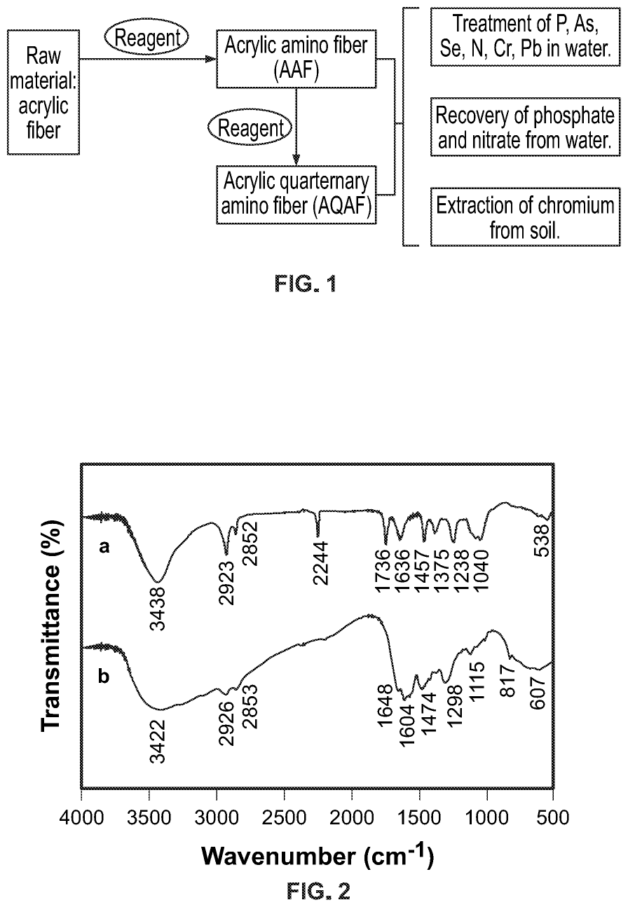

The fiber adsorbents containing primary and secondary amino groups are prepared by reacting acrylic fibers with amination reagents, such as tetraethylenepentamine at 70˜140° C. for 12 to 24 hours, rinsing the functionalized fibers with water, and drying it at 70˜100° C. for 2 to 4 hours to obtain acrylic amino fibers (AAF). Alternative amination reagents include ethylenediamine, diethylenetriamine, triethylenetetramine, tetraethylene pentamine, and polyethyleneimine. The AAF can be further modified to produce a cross linking acrylic quaternary amino fiber (AQAF) by treating the AAF with alkylating reagents, such as bromoethane at 70˜150° C. for 12 hours, rinsing the modified fiber with water, and drying in an oven at 70˜100° C. for 2 to 4 hours. Alternative alkylating reagents include bromopropane, bromobutane, bromopentane, chloroethane, chloropropane, chlorobutane, chloropentane, dichloroethane, 1,3dichloropropane, 1,4dichlorobutane, 1,5dichloropentane, 1,2dibromoethane, 1,3 dibromopropane, 1,4dibromobutane, and 1,5dibromopentane. A general flow diagram of the process is shown in FIG. 1.

Specifically, the concentration of the amination reagent is in the range of 5%-99% (w/w); the mass ratio of fiber to reagent is in the range of 1:0.5-1:10; and the functionalized fiber is treated with 0.1%-50% (w/w) HCl or HNO₃, washed with water, and then dried at 30-110° C.

The resulting functionalized fiber (i.e., AAF or AQAF) has high content of the functional groups, making them effective for the removal of heavy metals, phosphate and nitrate in water. Specifically, AAF is adapted to effectively remove heavy metals, while AQAF can remove chromate more effectively. Additionally, the fiber adsorbents can be regenerated using the acid or base solutions for reuse. The methods can also be used to functionalize nonwoven materials and fiber filters to convert them from sedimentation filters to adsorptive filters. Overall the functionalized fibers have high content of amino groups and high adsorption capacity. The AQAF in particular has superior adsorption capacity for nitrate and chromate, among other advantages.

The FTIR spectra of the acrylic fiber (AF) and acrylic amino fiber (AAF) are compared in FIG. 2. The spectrum of the AAF shows some significant changes after the reactions with tetraethylenepentamine. It can be seen that the peak at 2244 cm⁻¹ in the FTIR spectrum of AF almost completely disappeared, which suggests that most nitrile groups on the surface of the AF were converted during the reactions. The new bands peaks at 1648 cm⁻¹ (C═O stretching inamide group, C═N stretching), 1604, 1474 cm⁻¹ (NH blending in NH and NH₂), 1298 cm⁻¹ (C—N stretching and NH blending in NH), 1115 cm⁻¹ (C—N stretching in amide group), 817, 607 cm⁻¹ (NH blending) in the AAF spectrum suggest that the primary and secondary amino groups were introduced on the surface of the AAF.

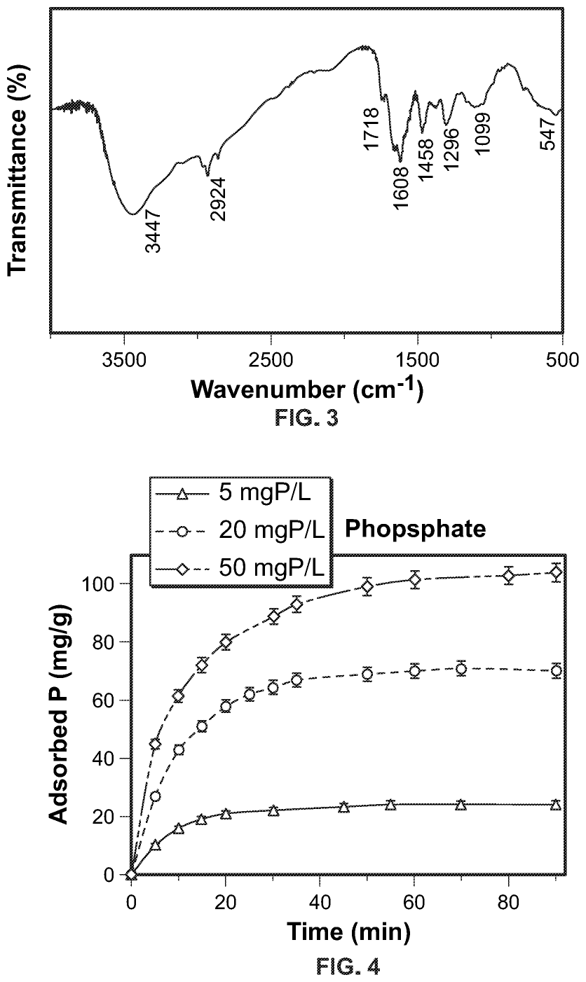

The AQAF FTIR spectrum in FIG. 3 shows a new peak at 1099 cm⁻¹ (C—N stretching) and the disappearance of the peak at 1474 cm⁻¹, which indicates that the majority of the primary and secondary amino groups were transformed into quaternary amino groups. With the method of the present invention, a fiber with quaternary amino groups was prepared through one step modification for the first time.

In an embodiment the manufacturing methods of the present invention may be used to prepare granular adsorbents. Granular acrylic particles can be functionalized with the same procedures to prepared granular adsorbents.

In the following examples, batch and column filtration experiments were conducted to evaluate the adsorption properties of the functionalized fibers.

### Example 1: Phosphate Removal

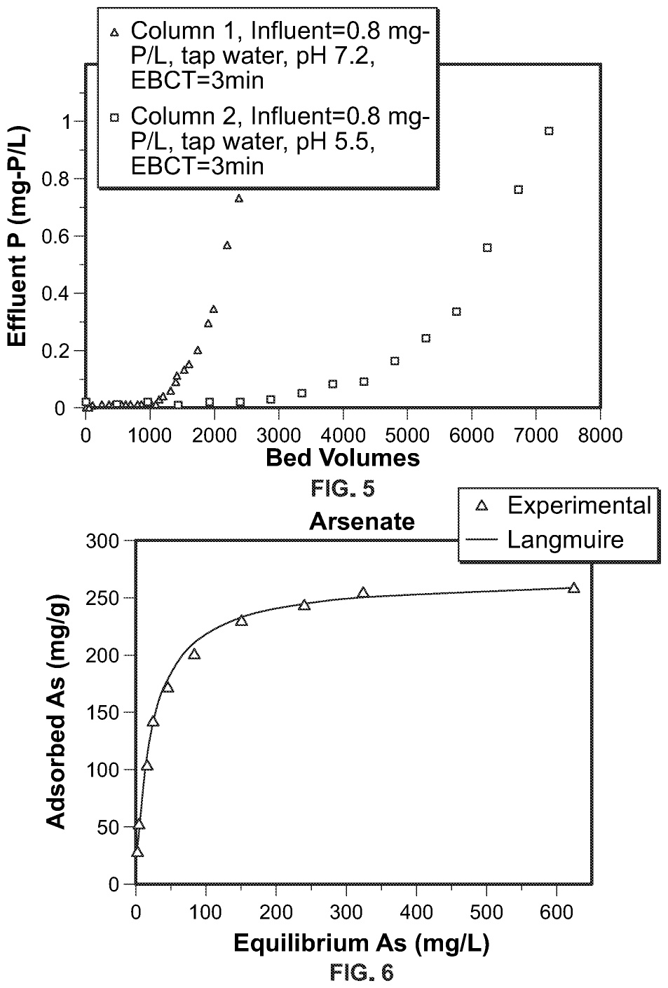

FIGS. 4 and 5 represent results from phosphate adsorption tests.

FIG. 4 shows the adsorption kinetics of phosphate onto AAF. Phosphate adsorption reached an equilibrium in about 60 min and the amount of adsorbed phosphate increased with increasing initial phosphate concentration. When the initial phosphate concentration was 50 mg-P/L, the amount of phosphate adsorbed AAF fiber was 104 mg-P/g. The initial phosphate concentrations were 5, 20, and 50 mg-P/L. The fiber adsorbent content was 0.2 g/L, ionic strength was 0.01M NaCl. The initial pH was 7.0±0.1.

FIG. 5 shows column filter results of phosphate from spiked tap water at different solution pH. The AAF was packed in columns for filtration removal of phosphate in water containing 0.8 mg-P/L. The filtration results in FIG. 5 show that the AAF filter could treat 1300 bed volumes of the water before the effluent phosphate concentration increased to 0.1 mg-P/L. When the solution pH was 5.5, 3900 bed volumes of the water was treated.

### Example 2: Arsenate Removal

FIG. 6. Adsorption of arsenate As(V) by AAF was tested. FIG. 6 shows the amount of arsenate adsorbed by the AAF increased when the equilibrium arsenate concentration increased from 5 to 250 mg-As/L. The maximum adsorption capacity of the fiber was 258 mg-As/g. Tested parameters were 0.2 g/L for fiber adsorbent content in 0.01 M NaCl solution, with an adsorption time of four hours at pH 7.0±0.1.

### Example 3: Selenium Removal

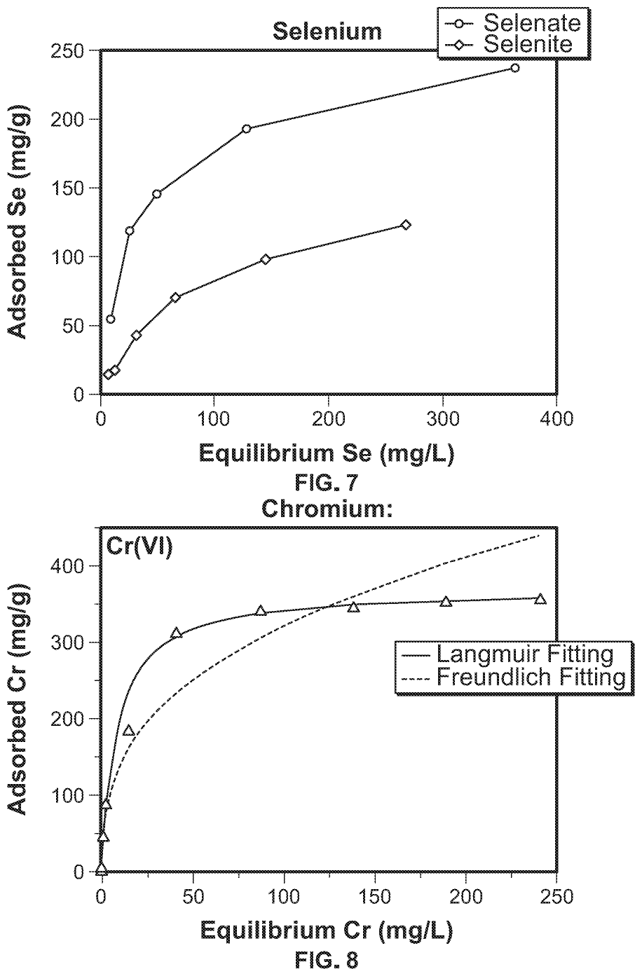

Selenium adsorption by AAF was tested in FIG. 7. Fiber adsorbent content was 0.2 g/L in tap water; adsorption time was 4 h, pH 7.0±0.1. The results in FIG. 7 indicate that the AAF has higher adsorption capacity for selenate than selenite. Because selenate is the predominant species in most wastewater and natural water and selenite can be easily oxidized to selenate, the AAF is especially suitable for treatment of selenium. On the other hand, the existing adsorbents, such as iron oxides, aluminum oxides, and titanium oxides, are not effective for selenate removal.

### Example 4: Chromium Removal

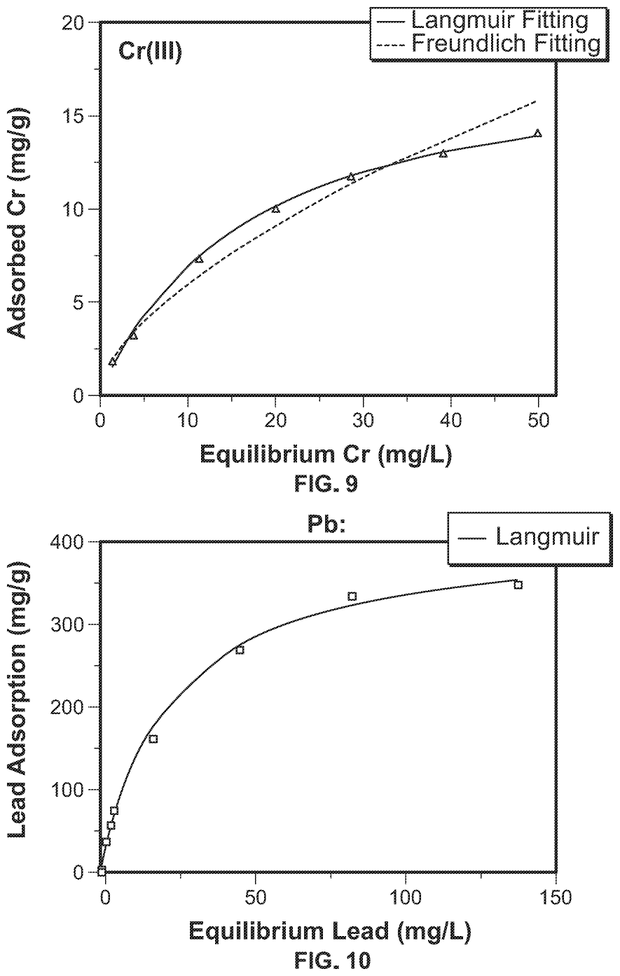

Chromium usually exists in chromate Cr(VI) and chromium cation Cr(III) species in water. Cr(VI) is more toxic and more difficult to remove by conventional water treatment techniques. The experimental results in FIG. 8 and FIG. 9 show that the AAF has much higher adsorption capacity for Cr(VI) than Cr(III). For FIG. 8, adsorption of Cr(VI), fiber adsorbent content was 0.2 g/L, ionic strength was 0.01 M NaCl, adsorption time was 4 hours, and pH was 6.0±0.2. For FIG. 9, fiber adsorbent content was 0.2 g/L, ionic strength was 0.01 M NaCl, adsorption time was 4 hours and pH was 5.0±0.2.

### Example 5: Lead Removal

FIG. 10 shows test results suggesting AAF has very high adsorption capacity for lead. Fiber adsorbent content was 0.2 g/L, ionic strength was 0.01 M NaCl, adsorption time was 4 hours, and pH was 5.0±0.2.

### Example 6: Nitrate Removal

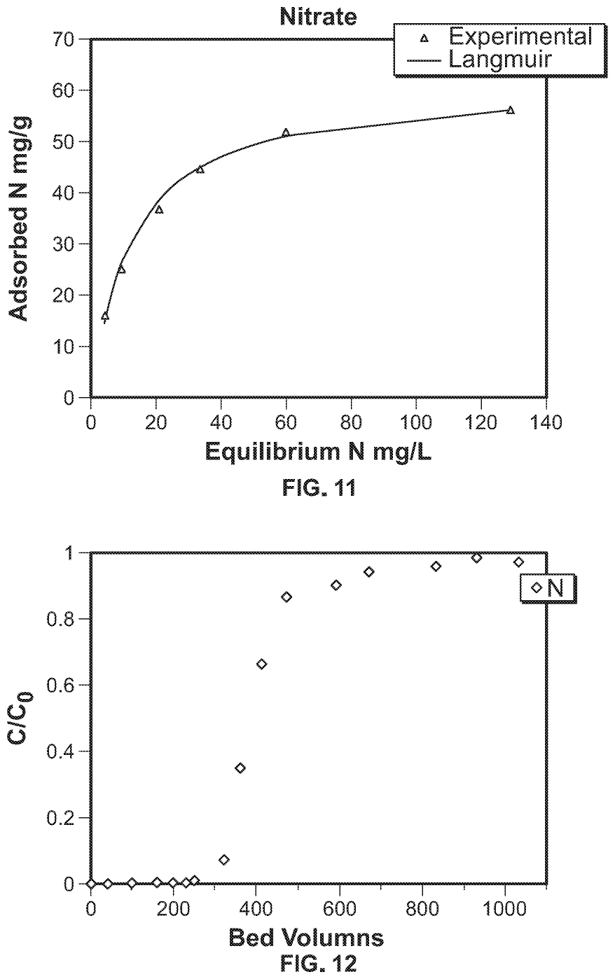

The AQAF was used for nitrate removal in batch and column experiments. The adsorption isotherms in FIG. 11 show that the maximum nitrate adsorption capacity of the adsorbent was 52 mg-N/g. The AQAF column could filter 310 bed volumes of water containing 20 mg/L of NO₃—N before nitrate breakthrough occurred in the column (FIG. 12).

Parameters for FIG. 11 were: fiber absorbent content=0.2 g/L, adsorption time=4 hours, pH 7.0±0.2, 20° C. For FIG. 12 the parameters were: influent nitrate concentration=20 mg-N/L, tap water, pH 7.0, EBCT 3 min.

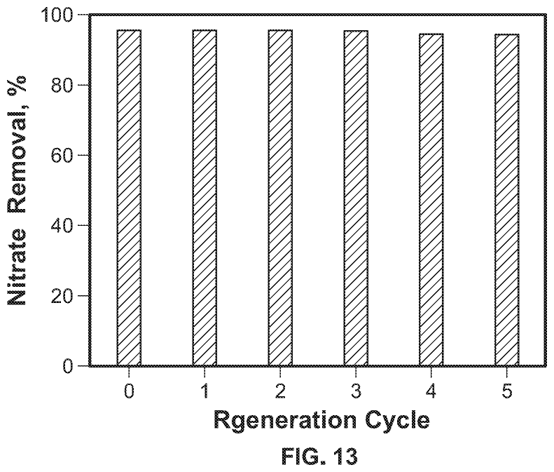

FIG. 13 shows nitrate removal by new and regenerated AQAF. 0.1M NaOH base solution was used as the regeneration solution in the experiment. After 6 cycles of filtration and regeneration, there was no decrease in the nitrate removal efficient of the AQAF. Initial nitrate concentration was 28 mg-N/L, fiber absorbent content was 2.5 g/L, adsorption time was 4 hours, pH was 7.0±0.2, and temperature was 20° C.

It will be understood that the embodiment described hereinabove is merely exemplary and that a person skilled in the art may make many variations and modifications without departing from the spirit and scope of the present invention.

What is claimed is:

1. A method of producing functionalized fibers adapted to remove contaminants from water and soil, comprising the step of reacting an acrylic fiber with an amination reagent to form a functionalized acrylic amino fiber.

2. The method of claim 1, wherein said amination reagent is selected from the group consisting of ethylenediamine, diethylenetriamine, triethylenetramine, tetraethylene pentamine, and polyethyleneimine.

3. The method of claim 2, wherein said acrylic fiber is reacted with said amination reagent at a temperature in a range of from 70° C. to 140° C. and for a period of time in a range of from 12 hours to 24 hours.

4. The method of claim 1, further comprising the steps of rinsing said functionalized acrylic amino fiber with water and then drying said functionalized acrylic amino fiber.

5. The method of claim 4, wherein said drying step is carried out at a temperature in a range of from 70° C. to 100° C.

6. The method of claim 5, wherein said drying step is carried out for a period of time in a range of from 2 hours to 4 hours.

7. The method of claim 1, further comprising the step of treating said functionalized acrylic amino fiber with an alkylating reagent to form a functionalized acrylic quaternary amino fiber.

8. The method of claim 7, wherein said alkylating reagent is selected from the group consisting of bromoethane, bromopropane, bromobutane, bromopentane, chloroethane, chloropropane, chlorobutane, chloropentane, dichloroethane, 1,3dichloropropane, 1,4dichlorobutane, 1,5dichloropentane, 1,2dibromoethane, 1,3dibromopropane, 1,4dibromobutane, and 1,5dibromopentane.

9. The method of claim 8, wherein said functionalized acrylic amino fiber is reacted with said alkylating reagent at a temperature in a range of from 70° C. to 150° C. for a period of time in a range from 4 hours to 20 hours.

10. The method of claim 7, further comprising the steps of rinsing said functionalized acrylic quaternary amino fiber with water and then drying said functionalized acrylic quaternary amino fiber.

11. The method of claim 10, wherein said drying step is carried out at a temperature in a range of from 70° C. to 100° C.

12. The method of claim 11, wherein said drying step is carried out for a period of time in a range of from 2 hours to 4 hours.

13. The method of claim 1, wherein the concentration of said amination reagent is in a range of 5% to 99% (w/w).

14. The method of claim 13, wherein the mass ratio of said acrylic fiber to said amination reagent is in a range of from 1:0.5 to 1:10.

15. The method of claim 14, further comprising the step of treating said functionalized acrylic amino fiber with 0.1%-50% (w/w) HCl or HNO₃.

16. The method of claim 15, further comprising the steps of washing said functionalized acrylic amino fiber with water and then drying said functionalized acrylic amino fiber.

17. The method of claim 16, wherein said drying step is carried out at a temperature in a range of from 30° C. to 110° C.

18. A method of producing functionalized fibers adapted to remove contaminants from water and soil, comprising the steps of reacting an acrylic fiber with an amination reagent to form a functionalized acrylic amino fiber and reacting said functionalized acrylic amino fiber with an alkylating reagent to form a functionalized acrylic quaternary amino fiber.

19. The method of claim 18, wherein said amination reagent is selected from the group consisting of ethylenediamine, diethylenetriamine, triethylenetramine, tetraethylene pentamine, and polyethyleneimine.

20. The method of claim 19, wherein said alkylating reagent is selected from the group consisting of bromoethane, bromopropane, bromobutane, bromopentane, chloroethane, chloropropane, chlorobutane, chloropentane, dichloroethane, 1,3dichloropropane, 1,4dichlorobutane, 1,5dichloropentane, 1,2dibromoethane, 1,3dibromopropane, 1,4dibromobutane, and 1,5dibromopentane.
